(19) United States
(12) Patent Application Publication
(10) Pub. No.: US 2008/0010417 A1
(43) Pub. Date: Jan. 10, 2008

(54) Read/Write Permission Bit Support for Efficient Hardware to Software Handover

(76) Inventors: Hakan E. Zeffer, Santa Clara, CA (US); Erik E. Hagersten, Uppsala (SE); Anders Landin, San Carlos, CA (US); Kevin Moore, San Francisco, CA (US)

Correspondence Address: Lawrence J. Merkel;Meyertons, Hood, Kivlin, Kowert & Goetzel, P.C., P.O. Box 398, Austin, TX, 78767-0398, US

(21) Appl. No.: 11/859,955

(22) Filed: Sep. 24, 2007

Related U.S. Application Data
(63) Continuation-in-part of application No. 11/413,243, filed on Apr. 28, 2006.

(51) Int. Cl. G06F 12/00

(52) U.S. Cl. 711/144; 711/E12.001

(57) ABSTRACT

In one embodiment, a method comprises communicating with one or more other nodes in a system from a first node in the system in response to a trap experienced by a processor in the first node during a memory operation, wherein the trap is signalled in the processor in response to one or more permission bits stored with a cache line in a cache accessible during performance of the memory operation; determining that the cache line is part of a memory transaction in a second node that is one of the other nodes, wherein a memory transaction comprises two or more memory operations that appear to execute atomically in isolation; and resolving a conflict between the memory operation and the memory transaction.

This application is a continuation-in-part of U.S. patent application Ser. No. 11/413,243, filed on Apr. 28, 2006, which is incorporated herein by reference in its entirety.

### BACKGROUND

1. Field of the Invention

This invention is related to the field of computer systems and, more particularly, to mechanisms for detecting memory violations in computer systems.

2. Description of the Related Art

Historically, shared memory multiprocessing systems have implemented hardware coherence mechanisms. The hardware coherence mechanisms ensure that updates (stores) to memory locations by one processor (or one process, which may be executed on different processors at different points in time) are consistently observed by all other processors that read (load) the updated memory locations according to a specified ordering model. Implementing coherence may aid the correct and predictable operation of software in a multiprocessing system. While hardware coherence mechanisms simplify the software that executes on the system, the hardware coherency mechanisms may be complex and expensive to implement (especially in terms of design time). Additionally, if errors in the hardware coherence implementation are found, repairing the errors may be costly (if repaired via hardware modification) or limited (if software workarounds are used).

Other systems have used a purely software approach to the issue of shared memory. Generally, the hardware in such systems makes no attempt to ensure that the data for a given memory access (particularly loads) is the most up to date. Software must ensure that non-updated copies of data are invalidated in various caches if coherent memory access is desired. While software mechanisms are more easily repaired if an error is found and are more flexible if changing the coherence scheme is desired, they typically have much lower performance than hardware mechanisms.

In addition to memory coherence, other types of memory violation detection can be supported for other purposes (e.g. debugging, transactional memory, etc.).

### SUMMARY

In one embodiment, a method comprises communicating with one or more other nodes in a system from a first node in the system in response to a trap experienced by a processor in the first node during a memory operation, wherein the trap is signalled in the processor in response to one or more permission bits stored with a cache line in a cache accessible during performance of the memory operation; determining that the cache line is part of a memory transaction in a second node that is one of the other nodes, wherein a memory transaction comprises two or more memory operations that appear to execute atomically in isolation; and resolving a conflict between the memory operation and the memory transaction. A computer accessible storage medium storing a plurality of instructions that are executable to implement the method is also contemplated.

In another embodiment, a cache comprises a tag memory and a cache control unit coupled thereto. The tag memory is configured to store a plurality of cache tags. Each cache tag corresponds to a respective cache line of data stored in the cache and comprises one or more bits that indicate whether or not a memory operation to the respective cache line is to be trapped in a processor that performs the memory operation. The cache control unit is configured to signal a trap for a memory operation responsive to the bits from the cache tag.

### BRIEF DESCRIPTION OF THE DRAWINGS

The following detailed description makes reference to the accompanying drawings, which are now briefly described.

FIG. 1 is a block diagram of one embodiment of a system.

FIG. 2 is a block diagram of one embodiment of a cache.

FIG. 3 is a flowchart illustrating operation of one embodiment of a cache during a load operation.

FIG. 4 is a flowchart illustrating operation of one embodiment of a cache during a store operation.

FIG. 5 is a flowchart illustrating operation of one embodiment of a cache during a fill operation.

FIG. 6 is a flowchart illustrating one embodiment of transactional memory code.

FIG. 7 is a flowchart illustrating one embodiment of coherence code.

FIG. 8 is a block diagram of one embodiment of a load data path in a processor.

FIG. 9 is a block diagram of one embodiment of a store commit path in a processor and an associated cache.

FIG. 10 is a block diagram of one embodiment of a cache tag.

FIG. 11 is a block diagram of one embodiment of fill logic within a cache.

FIG. 12 is a flowchart illustrating operation of one embodiment of a cache control unit during a fill.

FIG. 13 is a flowchart illustrating one embodiment of coherence code.

FIG. 14 is a block diagram of one embodiment of a computer accessible medium.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

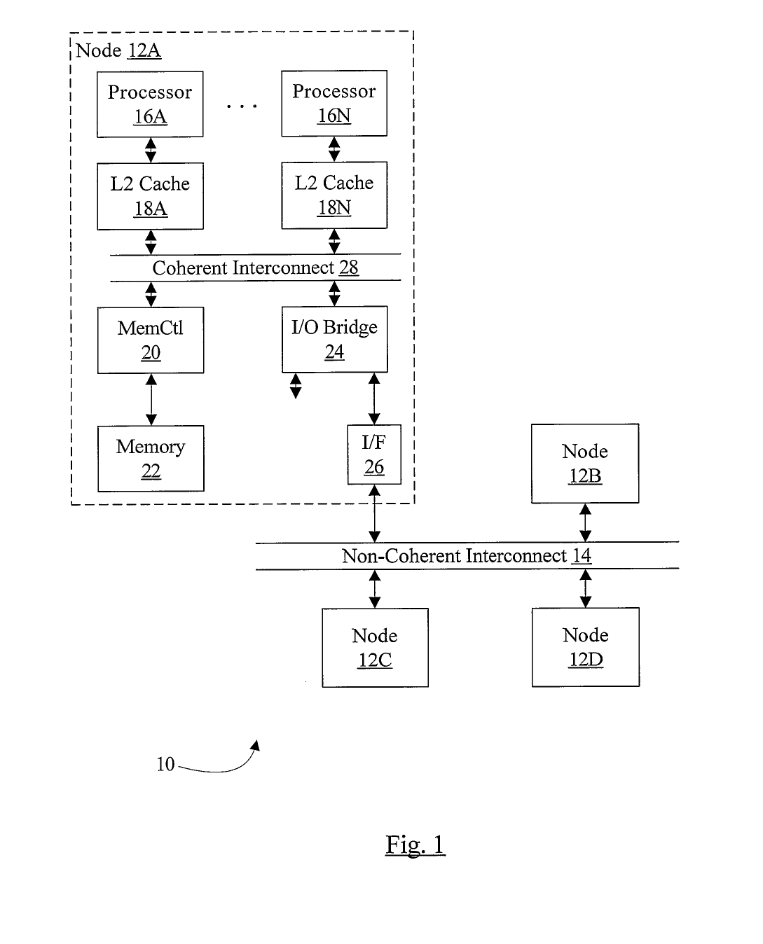

Turning now to FIG. 1, a block diagram of one embodiment of a system 10 is shown. In the illustrated embodiment, the system 10 comprises a plurality of nodes 12A-12D coupled to a non-coherent interconnect 14. The node 12A is shown in greater detail for one embodiment, and other nodes 12B-12D may be similar. In the illustrated embodiment, the node 12A includes one or more processors 16A-16N, corresponding L2 caches 18A-18N, a memory controller 20 coupled to a memory 22, an input/output (I/O) bridge 24 coupled to one or more I/O interfaces including an interface 26 to the interconnect 14. In the illustrated embodiment, the L2 caches 18A-18N are coupled to respective processors 16A-16N and to a coherent interconnect 28. In other embodiments, a given L2 cache may be shared by two or more processors 16A-16N, or a single L2 cache may be shared by all processors 16A-16N. In still other embodiments, the L2 caches 18A-18N may be eliminated and the processors 16A-16N may couple directly to the interconnect 28. The memory controller 20 is coupled to the interconnect 28, and to the memory 22.

The memory 22 in the node 12A and similar memories in other nodes 12B-12D may form a distributed shared memory for the system 10. In the illustrated embodiment, each node 12A-12D implements hardware-based coherence internally. The distributed shared memory may also be coherent. The coherence of the distributed shared memory may be maintained primarily in software, with hardware support in the processors 16A-16N and the L2 caches 18A-18N. The memory system (memory controller 20 and memory 22) may remain unchanged from an embodiment in which the node 12A is the complete system, in some embodiments. In other embodiments, the memory system may be modified (e.g. to store the read and write permission bits described below).

In one embodiment, the distributed shared memory may support transactional memory operation. In transactional memory, two or more memory operations performed by the same thread may appear to occur atomically (with respect to other threads) and in isolation. The mechanisms for maintaining the atomicity and isolation of the transaction may vary from embodiment to embodiment, and may be maintained primarily in software also. The memory operations forming a particular transaction may be referred to collectively as a memory transaction. Thus, the memory operations (and the cache lines accessed by those memory operations) may be referred to as being part of the memory transaction. Two or more memory operations may be atomic if the operations, as a group, are either performed successful or have not been performed at any logical point in time (e.g. as viewed by memory operations performed from another process). For example, other accesses to the memory locations accessed by one of the atomic memory operations receive only data that existed before the two memory operations or that exists after all memory operations have completed.

The system 10 may provide some hardware support for transactional memory operations. Specifically, in one embodiment, the caches may support one or more software-addressable bits that control whether or not a memory operation is trapped during performance of the memory operation. For example, a read permission bit and a write permission bit may be supported for each cache line in the cache. The read permission bit may whether or not read access to the cache line is permitted for memory operations performed by the processor or processors coupled to that cache for access. The write permission bit may similarly indicate whether or not write access to the cache line is permitted for memory operations performed by the processor or processors. Each bit may indicate permission when set and no permission when clear (or vice versa). The hardware support in this embodiment may include checking the permission bits for memory operations and trapping if permission is not provided, and may also include copying the permission bits between cache levels in a cache hierarchy (e.g. between L1 caches in the processors 16A-16N and the L2 caches 18A-18N). In one embodiment, the permission bits may also be provided per cache line in the memory 22.

The permission bits may be controlled by software to ensure that a memory operation that might interfere with an in-progress transaction is trapped, so that the transactional memory software may manage the access and its interference with the transaction (e.g. by aborting the transaction or providing pre-transaction values), or may prevent the interference. Similarly, the permission bits may be used to cause traps so that coherence activity may be performed to maintain internode cache coherency. Since the permission bits are software addressable, other uses are contemplated as well. For example, the permission bits may be used for setting watch points, or break points, for debugging purposes at a cache line granularity. That is, one or both permission bits may be cleared to cause traps on memory accesses to the cache line. Thus, a break point for any address in the cache line is set. The number of break points that can be set may be essentially unlimited, up to all of the cache lines in memory. The trap that occurs when a break point is hit may cause hand over of execution to the debugger. Break points can also be used to profile memory accesses by a thread/program being executed, or for hardware emulation.

In another embodiment, the hardware support for transactional memory, coherence, etc. may comprise detecting a designated value in the data accessed by a memory operation executed by a processor 16A-16N, and trapping to a software routine in response to the detection. The designated value may be used by the software mechanism to indicate that the data is invalid in the node. That is, the coherent copy of the data being accessed exists in another node, and coherence activity is needed to obtain the data and/or the right to access the data as specified by the memory operation. Or, the data being accessed is possibly part of a memory transaction in another node and the software transactional memory system is to manage the access to ensure the atomicity of the in-progress transaction (e.g. through delaying the access, aborting the in-progress transaction, or aborting a transaction of which the memory access is a part, if applicable). The designated value may also be referred to as the coherence trap (CT) value for an embodiment below in which the trap is used for a coherency embodiment, other embodiments may implement the trap value for other purposes, as mentioned above.

As used herein, a memory operation may comprise any read or write of a memory location performed by a processor as part of executing an instruction. A load memory operation (or more briefly, a load) is a read operation that reads data from a memory location. A store memory operation (or more briefly, a store) is a write operation that updates a memory location with new data. The memory operation may be explicit (e.g. a load or store instruction), or may be an implicit part of an instruction that has a memory operand, based on the instruction set architecture (ISA) implemented by the processors 16A-16N.

Generally, a “trap” may refer to a transfer in control flow from an instruction sequence being executed to a designated instruction sequence that is designed to handle a condition detected by the processor 16A-16N. In some cases, trap conditions may be defined in the ISA implemented by the processor. In other cases, or in addition to the ISA-defined conditions, an implementation of the ISA may define trap conditions. Traps may also be referred to as exceptions.

In one embodiment, the processors 16A-16N may implement the SPARC instruction set architecture, and may use the exception trap vector mechanism defined in the SPARC ISA. One of the reserved entries in the trap vector may be used for the coherence trap, and the alternate global registers may be used in the coherence routines to avoid register spill. Other embodiments may implement any ISA and corresponding trap/exception mechanism.

Providing some hardware for coherence/transactional memory/etc. in the distributed shared memory may simplify software management, in some embodiments. Additionally, in some embodiments, performance may be improved as compared to a software-only implementations.

Each processor 16A-16N may comprise circuitry for executing instructions defined in the instruction set architecture implemented by the processor. Any instruction set architecture may be used. Additionally, any processor microarchitecture may be used, including multithreaded or single threaded, superscalar or scalar, pipelined, superpipelined, in order or out of order, speculative or non-speculative, etc. In one embodiment, each processor 16A-16N may implement one or more level 1 (L1) caches for instructions and data, and thus the caches 18A-18N are level 2 (L2) caches. The processors 16A-16N may be discrete microprocessors, or may be integrated into multi-core chips. The processors 16A-16N may also be integrated with various other components, including the L2 caches 18A-18N, the memory controller 20, the I/O bridge 24, and/or the interface 26.

The L2 caches 18A-18N comprise high speed cache memory for storing instructions/data for low latency access by the processors 16A-16N. The L2 caches 18A-18N are configured to store a plurality of cache lines, which may be the unit of allocation and deallocation of storage space in the cache. The cache line may comprise a contiguous set of bytes from the memory, and may be any size (e.g. 64 bytes, in one embodiment, or larger or smaller such as 32 bytes, 128 bytes, etc.). The L2 caches 18A-18N may have any configuration (direct-mapped, set associative, etc.) and any capacity. Cache lines may also be referred to as cache blocks, in some cases.

The memory controller 20 is configured to interface to the memory 22 and to perform memory reads and writes responsive to the traffic on the interconnect 28. The memory 22 may comprise any semiconductor memory. For example, the memory 22 may comprise random access memory (RAM), such as static RAM (SRAM) or dynamic RAM (DRAM). Particularly, the memory 22 may comprise asynchronous or synchronous DRAM (SDRAM) such as double data rate (DDR or DDR2) SDRAM, RAMBUS DRAM (RDRAM), etc.

The I/O bridge 24 may comprise circuitry to bridge between the interconnect 28 and one or more I/O interconnects. Various industry standard and/or proprietary interconnects may be supported, e.g. peripheral component interconnect (PCI) and various derivatives thereof such as PCI Express, universal serial bus (USB), small computer systems interface (SCSI), integrated drive electronics (IDE) interface, Institute for Electrical and Electronic Engineers (IEEE) 1394 interfaces, Infiniband interfaces, HyperTransport links, network interfaces such as Ethernet, Token Ring, etc. In other embodiments, one or more interface circuits such as the interface 26 may directly couple to the interconnect 28 (i.e. bypassing the I/O bridge 24).

The coherent interconnect 28 comprises any communication medium and corresponding protocol that supports hardware coherence maintenance. The interconnect 28 may comprise, e.g., a snoopy bus interface, a point to point packet interface with probe packets included in the protocol (or other packets used for coherence maintenance), a ring interface, etc. The non-coherent interconnect 14 may not include support for hardware coherency maintenance. For example, in one embodiment, the interconnect 14 may comprise Infiniband. Other embodiments may use any other interconnect (e.g. HyperTransport non-coherent, various I/O or network interfaces mentioned above, etc.). In other embodiments, the interconnect 14 may include support for hardware coherence maintenance, but such support may not be used to maintain coherence over the distributed shared memory system.

The system 10 as a whole may have any configuration. For example, the nodes 12A-12D may be “blades” in a blade server system, stand-alone computers coupled to a network, boards in a server computer system, etc.

It is noted that, while 4 nodes are shown in the system 10 in FIG. 1, other embodiments may include any number of 2 or more nodes, as desired. The number of processors 16A-16N in a given node may vary, and need not be the same number as other nodes in the system.

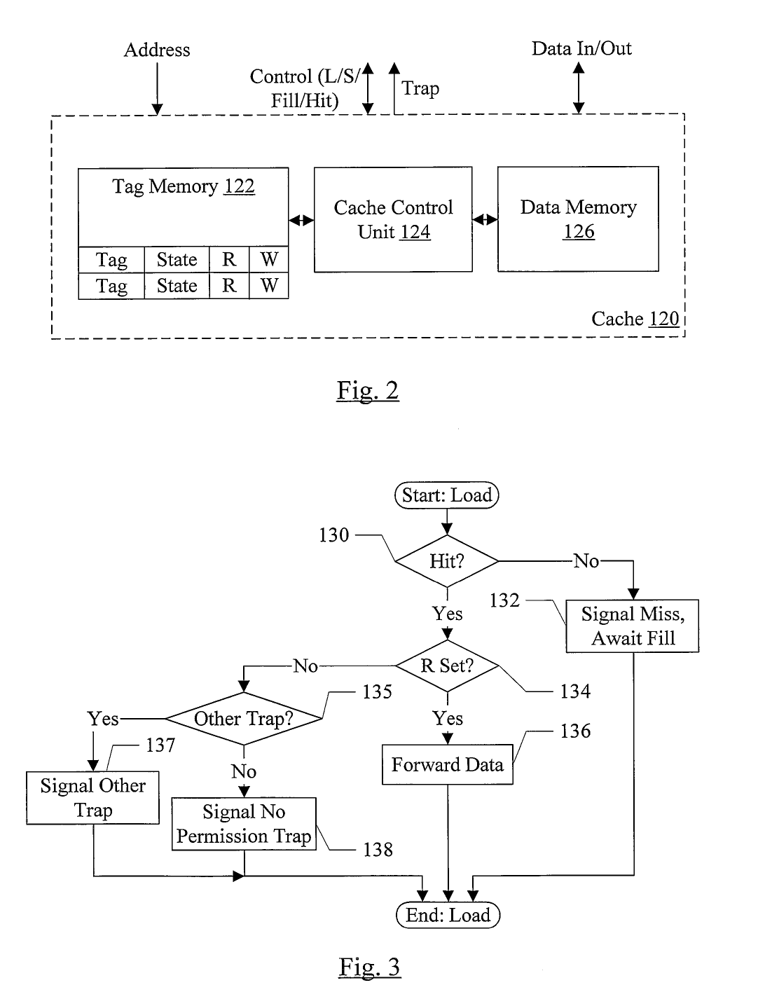

Turning now to FIG. 2, a block diagram of one embodiment of a cache 120 is shown. The cache 120 may be, in various embodiments, an L1 cache in one of the processors 16A-16N, one of the L2 caches 18A-18N, or a cache at any other level of a cache hierarchy. The cache 120 includes a tag memory 122, a cache control unit 124, and a data memory 126. The cache control unit 124 is coupled to the tag memory 122 and the data memory 126. The cache 120 has an interface including one or more ports. Each port includes an address input, control interface, and a data interface. The control interface may include various signals (e.g. inputs indicating load, store, or fill (L/S/Fill), a hit output, size of operation, etc.). The control interface may also include a trap line to signal a trap to the processor. The data interface may include data-in lines (for a read port or read/write port) and data-out lines (for a write port or read/write port). Any number of ports may be supported in various embodiments.

The tag memory 122 may comprise a plurality of entries, each entry storing a cache tag for a corresponding cache line in the data memory 126. That is, there may be a one-to-one correspondence between cache tag entries and cache data entries in the data memory 126, where each data entry stores a cache line of data. The tag memory 122 and data memory 126 may have any structure and configuration, and may implement any cache configuration for the cache 120 (set associative, direct mapped, fully associative, etc.).

Exemplary cache tags for two tag entries in the tag memory 122 are shown in FIG. 2 for one embodiment. In the illustrated embodiment, the cache tag includes an address tag field (“Tag”), a state field (“State”), a read permission bit (“R”) and a write permission bit (“W”). The read and write permission bits may be the permission bits described above.

The state field may store various other state (e.g. whether or not the cache line is valid and/or modified, replacement data state for evicting a cache line in the event of a cache miss, intranode coherence state as established by the intranode coherence scheme implemented on the coherent interconnect 28, etc.). The address tag field may store the tag portion of the address of the cache line (e.g. the address tag field may exclude cache line offset bits and bits used to index the cache to select the cache tag). That is, the address tag field may store the address bits that are to be compared to the corresponding bits of the address input to detect hit/miss in the cache 120. It is noted that the tag memory 122 may be implemented as two or more structures (e.g. separate structures for each of the cache tags, the states, and the R and W bits), if desired.

Turning next to FIG. 3, a flowchart is shown illustrating operation of one embodiment of the cache control unit 124 for a load memory operation accessing the cache 120. While the blocks are shown in a particular order for ease of understanding, any order may be used. Blocks may be performed in parallel in combinatorial logic in the cache control unit 124. Blocks, combinations of blocks, and/or the flowchart as a whole may be pipelined over multiple clock cycles.

If the load memory operation is a miss in the cache 120 (decision block 130, “no” leg), the cache control unit 124 may signal a miss to the processor and may await the cache fill supplying the cache line for storage (block 132). Alternatively, the cache control unit 124 may itself initiate the cache fill (e.g. in the case of the L2 caches 18A-18N). The cache control unit 124 may signal miss by deasserting the hit signal on the control interface, for example.

If the load memory operation is a hit in the cache 120 (decision block 130, “yes” leg), the read permission bit indicates that a read is permitted (decision block 134, “yes” leg), the cache control unit 124 may signal a hit in the cache and may return the data from the cache line in the data memory 126 (block 136). It is noted that, if a trap is detected for the load memory operation (e.g. TLB miss, ECC error, etc.), the trap may be signalled instead of forwarding the load data. If another trap is detected, the other trap may be signalled (decision block 135, “yes” leg and block 137). If the read permission bit does not indicate that a read is permitted (decision block 134, “no” leg) and no other trap is detected (decision block 135, “no” leg), the cache control unit 124 may signal a trap to the processor's trap logic (block 138). It is noted that other prioritizations/orderings of the traps, if more than one trap is detected for the same load memory operation, may be implemented in other embodiments.

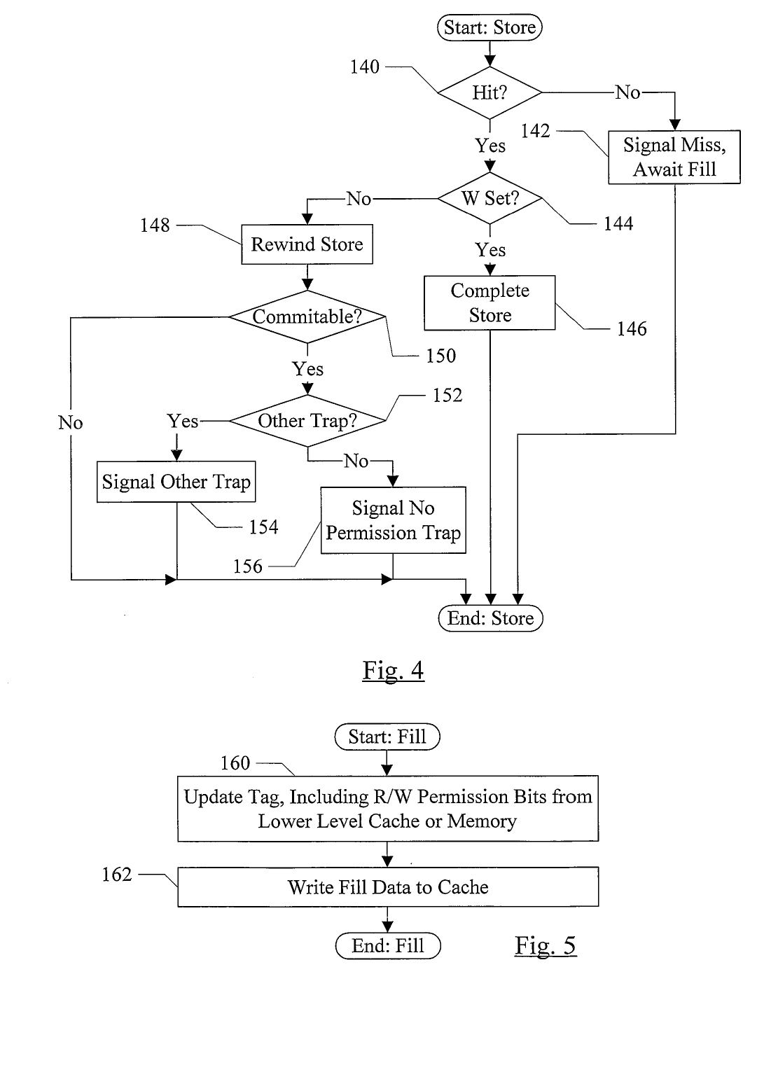

Turning now to FIG. 4, a flowchart is shown illustrating operation of one embodiment of the cache control unit 124 for a store memory operation accessing the cache 120. While the blocks are shown in a particular order for ease of understanding, any order may be used. Blocks may be performed in parallel in combinatorial logic in the cache control unit 124. Blocks, combinations of blocks, and/or the flowchart as a whole may be pipelined over multiple clock cycles.

If the store memory operation is a miss in the cache 120 (decision block 140, “no” leg), the cache control unit 124 may signal a miss to the processor and may await the cache fill supplying the cache line for storage (block 142). Alternatively, the cache control unit 124 may itself initiate the cache fill (e.g. in the case of the L2 caches 18A-18N). In yet another alternative, no fill may be initiated for a cache miss by a store memory operation and the store memory operation may be passed to the next level of the memory hierarchy (e.g. the next level cache or the main memory).

If the store memory operation is a hit in the cache 120 (decision block 140, “yes” leg), and the write permission bit indicates that a write is permitted (decision block 144, “yes” leg), the cache control unit 124 may signal a hit in the cache and may complete the store, updating the hitting cache line in the data memory 126 with the store data (block 146). It is noted that, while a no permission trap does not occur in this case, it is possible that other traps have been detected. Similar to decision block 152 (described below), other traps may be signalled instead of completing the store.

If the write permission bit does not indicate that a write is permitted (decision block 144, “no” leg), the cache control unit 124 may “rewind” the store memory operation (block 148). Rewinding the store memory operation may generally refer to undoing any effects of the store memory operation that may have been speculatively performed, although the mechanism may be implementation specific. For example, instructions subsequent to the store memory operation may be flushed and refetched. If the store memory operation is committable (e.g. no longer speculative—decision block 150, “yes” leg), and there is another trap detected for the store besides the write permission trap (decision block 152, “yes” leg), the other trap may be signalled for the store memory operation (block 154). If no other trap has been signalled (decision block 152, “no” leg), the cache control unit 124 may signal the no permission trap (block 156). If the store memory operation is not committable, no further action may be taken (decision block 150, “no” leg). The store memory operation may be reattempted at a later time when the store is committable, or the trap may be taken at the time that the store is committable. It is noted that other prioritizations/orderings of the traps, if more than one trap is detected for the same store memory operation, may be implemented in other embodiments.

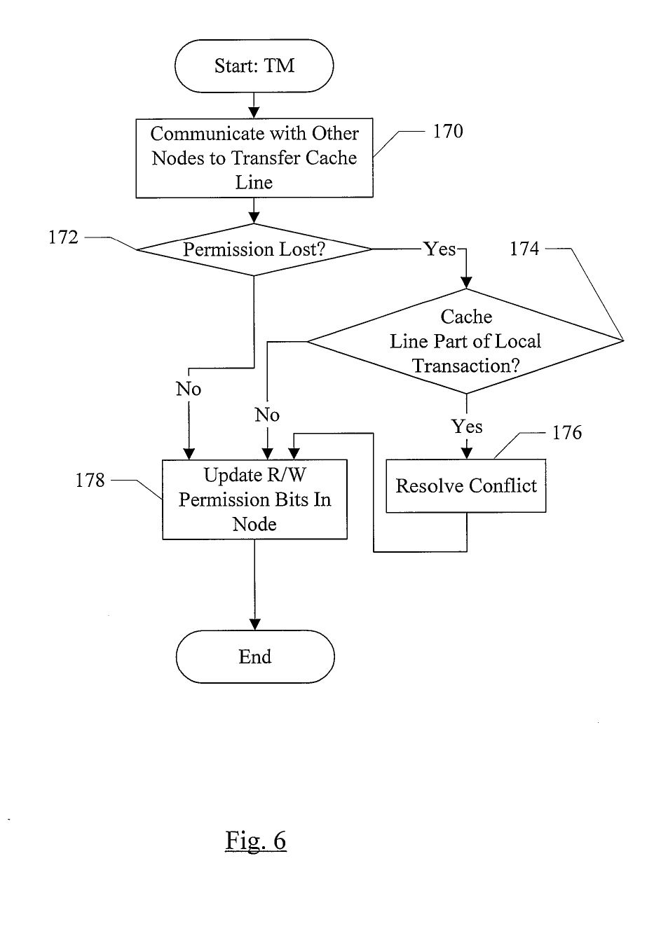

Turning now to FIG. 5, a flowchart is shown illustrating operation of one embodiment of the cache control unit 124 for a fill to the cache 120. While the blocks are shown in a particular order for ease of understanding, any order may be used. Blocks may be performed in parallel in combinatorial logic in the cache control unit 124. Blocks, combinations of blocks, and/or the flowchart as a whole may be pipelined over multiple clock cycles.

The cache control unit 124 may update the cache tag of the cache entry to which the fill is targeted in the tag memory 122 (block 160). The cache entry may be selected using any replacement algorithm. The address tag and state data may be written. Additionally, the read/write permission bits, provided from the source of the data (e.g. a lower level cache or the main memory) may be written to the tag. Thus, the current permission may be propagated within the node with the data. Alternatively, traps could be signalled and the trap code could discover the permission bits in the lower level cache or main memory. The cache control unit 124 may also cause the fill data to be written to the data memory 126 (block 162).

Turning now to FIG. 6, a flowchart is shown illustrating one embodiment of transactional memory code (transactional memory routine(s)) that may be executed in response to a trap, to implement transactional memory. While the blocks are shown in a particular order for ease of understanding, other orders may be used. The transactional memory code may comprise instructions which, when executed in the system 10, implement the operation shown in FIG. 6.

The transactional memory code may communicate with other nodes (e.g. the transactional memory code in other nodes) to transfer the missing cache line to the node (block 170). If desired, the cache line may be coherently transferred. Any software coherence protocol may be used. If the cache line is already present in the node, but read or write permission is not provided, then the transfer may be omitted and the transactional memory code may attempt to obtain the desired permission.

Additionally, the transactional memory code may determine if the permission (read, write, or both) to the transferred cache line would be lost by the node (decision block 172). A node that is transferring the cache line away may lose read permission, for example, if the receiving node will be writing the cache line. A node that is transferring the cache line away may lose write permission if the receiving node is expecting that the cache line will not be updated while the receiving node has the cache line. Additionally, even if the cache line itself is not being transferred, permission may be lost based on the permission requested by another node. If permission is being lost (decision block 172, “yes” leg), the transactional memory code may determine if the cache line is part of the local transaction (decision block 174). For example, one or more data structures may be maintained that describe a transaction's read set (those memory locations that are read as part of the transaction) and write set (those memory locations that are written as part of the transaction). The data structures may comprise, for example the set bits (or sbits) of the transaction. If the cache line is part of a local transaction (decision block 174, “yes” leg), the transactional memory code may resolve the conflict (block 176). Resolving the conflict may include, for example, delaying the memory operation until the transaction completes, aborting the transaction that would lose the permission, or aborting the transaction that is attempting to gain the permission. The transactional memory code may update the read and write permission bits in the node based on the conflict resolution (block 178), and may also update the transactional memory data structures, if appropriate. Additionally, the if the cache line is not part of a local transaction (decision block 174, “no” leg) or the permission is not being lost (decision block 172, “no” leg), the transactional memory code may update the read/write permission bits in the node to reflect the obtained permission (block 178).

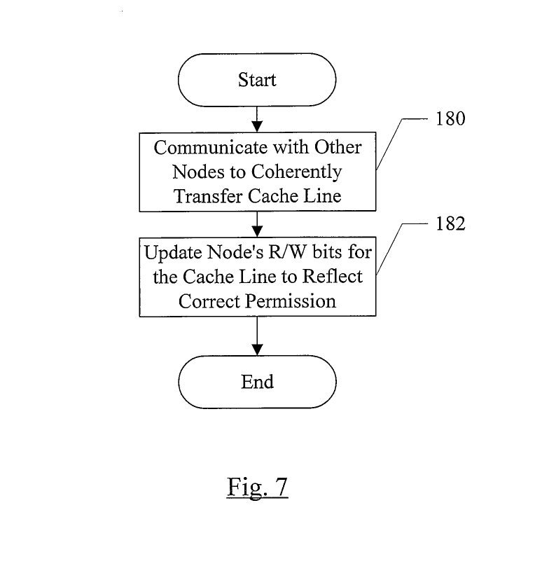

Turning now to FIG. 7, a flowchart is shown illustrating one embodiment of coherence code (coherence routine(s)) that may be executed in response to a trap, to maintain memory coherence using the read/write permission bits. While the blocks are shown in a particular order for ease of understanding, other orders may be used. The coherence code may comprise instructions which, when executed in the system 10, implement the operation shown in FIG. 7.

The coherence code may communicate with other nodes (e.g. the coherence code in other nodes) to coherently transfer the missing cache line to the node (block 180). Any software coherence protocol may be used. The coherency code may update the node's read/write permission bits to reflect permission granted according to the software coherence protocol (block 182). For example, if the trap occurred for a store that did not have write permission, the write permission bit may be set. If the trap occurred or a load that did not have read permission, the read permission bit may be set. The write permission bit may also be set, in the case of a load, if write permission is granted (e.g. if there are no other coherent copies in other nodes).

It is noted that the coherence code may be implemented in addition to, or in conjunction with, the transactional memory code illustrated in FIG. 6. Furthermore, other code may be implemented (e.g. debugging code to transfer control to a debugger, or simulation code to transfer control to a simulator). Such other code may be implemented in addition to, or conjunction with, the transactional memory code and/or coherence code as well. It is noted that the permission bits described above or the designated value describe below may permit essentially unlimited watch point creation, at the cache line level of granularity. Such watch point flexibility may have numerous uses, over and above the coherence, transactional memory, debugging, and simulation uses described herein.

In another embodiment, instead of the permission bits described above, a designated value may be used to detect the trap. Such an embodiment is described below in more detail, specifically with respect to a coherence embodiment. However, the designated value can also be used to implement transactional memory, debugging, and/or simulation similar to the above description.

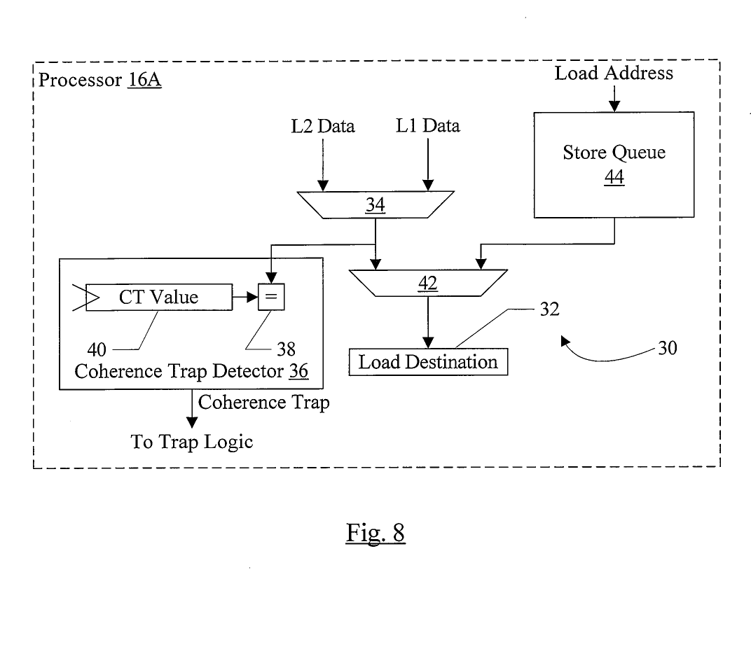

Turning now to FIG. 8, a block diagram of one embodiment of a portion of the processor 16A is shown in more detail. Other processors may be similar. Specifically, FIG. 8 illustrates a load data path 30 in the processor 16A for delivering load data from one or more data sources to a load destination location 32. The location 32 may comprise an architected register file, an implemented register file if register renaming is implemented, a reorder buffer, etc. In the illustrated embodiment, the data path 30 includes a mux 34 coupled to receive data from an L1 cache in the processor 16A, and the L2 cache 18A. The output of the mux 34 is coupled to a store merge mux 42 and to a coherence trap detector 36 (and more particularly a comparator 38 in the coherence trap detector 36, in the illustrated embodiment, which has another input coupled to a coherence trap (CT) value register 40). The store merge mux 42 is further coupled to receive data from a store queue 44, which is coupled to receives the load address (that is, the address of the data accessed by the load).

The coherence trap detector 36 is configured to detect whether or not the data being provided for the load is the designated value indicating that a coherence trap is needed to coherently access the data. In the illustrated embodiment, the CT value is programmable in the CT value register 40. The CT value register 40 may be software accessible (i.e. readable/writable). The CT value register 40 may, e.g., be an implementation specific register, model specific register, etc. Having the CT value programmable may provide flexibility in the scheme. For example, if a given CT value is too often causing false traps (traps that occur because the CT value is the actual, valid value that is the result of the memory access), the CT value can be changed to a less frequently occurring value. Other embodiments may employ a fixed value (e.g. “DEADBEEF” in hexadecimal, or any other desired value).

The size of the CT value may vary from embodiment to embodiment. For example, the size may be selected to be the default size of load/store operations in the ISA. Alternatively, the size may be the most commonly used size, in practical code executed by the processors. For example, the size may be 32 bits or 64 bits, in some embodiments, although smaller or larger sizes may be used.

The comparator 38 compares the load data to the CT value to detect the CT value. In fixed CT value embodiments, the coherence trap detector 36 may decode the load data. In either case, the coherence trap detector 36 may assert a coherence trap signal to the trap logic in the processor 16A. In some embodiments, the output of the comparator 38 may be the coherence trap signal. In other embodiments, the comparison may be qualified. For example, the comparison may be qualified with an indication that the CT value register 40 is valid, a mode indication indicating that the coherence trap is enabled, etc.

As mentioned above, the load data path 30 directs load data from one or more data sources to the load destination 32. The mux 34 selects among possible non-speculative sources (such as the L1 and L2 caches). Additional non-speculative sources may include the memory 22 or other cache levels. While a single mux 34 is shown in FIG. 8, any selection circuitry may be used (e.g. hierarchical sets of muxes).

Additionally, some or all of the load data may be supplied by one or more stores queued in the store queue 44. The store queue 44 may queue store addresses and corresponding store data to be written to the caches and/or the memory for uncommitted store operations. If a given store precedes the load and updates one or more bytes accessed by the load, the store data is actually the correct data to forward to the load destination 32 for those bytes (assuming that the store is ultimately retired and commits the data to memory). The store queue 44 may receive the load address corresponding to the load, and may compare the address to the store addresses. If a match is detected, the store queue 44 may forward the corresponding data for the load. Accordingly, the store merge mux 42 is provided to merge memory data with store data provided from the store queue 44.

The coherence trap detector 36 is coupled to receive the data from the load data path prior to the merging of the store data. In general, the coherence trap detector 36 may receive the data from any point in the load data path that excludes store data from the store queue 44. The store queue 44 stores actual data to be written to memory, and thus is known to be valid data (not the designated value indicating that a trap is to be taken). Furthermore, the stores in the store queue 44 may be speculative. Accordingly, there is no guarantee that the data from the memory location(s) written by the store is valid in the node, or that the node has write permission to the memory location(s). By checking the data prior to the merging of the store data, the CT value may be observed prior to overwriting by the store data. Furthermore, the check may be performed, in some embodiments, to maintain total store ordering (TSO), if TSO is implemented. The check may be implementation-specific, and may not be implemented in other embodiments.

The trap logic may associate a trap signalled by the coherence trap detector 36 with the appropriate instruction. Alternatively, an identifier may be assigned to the memory operation and pipelined with the operation. The coherence trap detector 36 may forward the identifier with the coherence trap indication to the trap logic. In yet another embodiment, the address at which the corresponding instruction is stored (often referred to as the program counter, or PC) may be forwarded to identify the instruction.

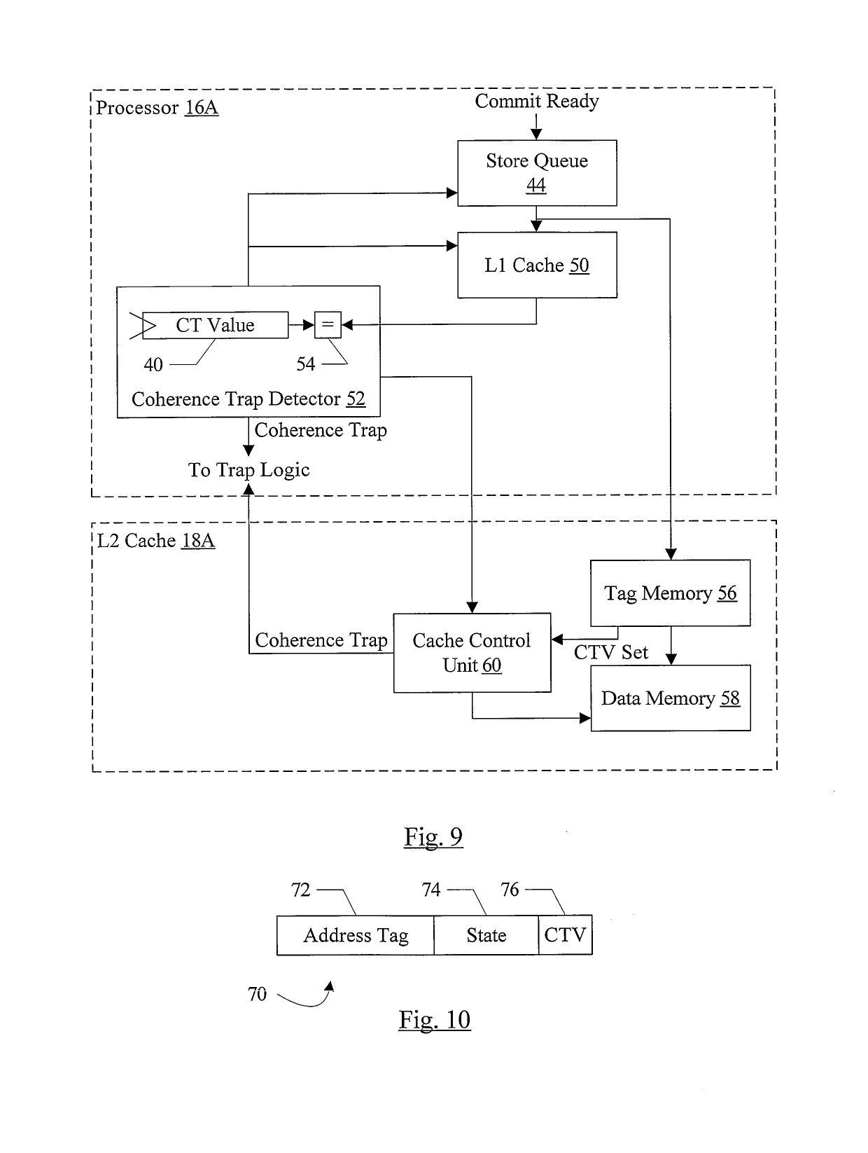

Turning next to FIG. 9, a block diagram of one embodiment of a portion of the processor 16A is shown in more detail. Other processors may be similar. Specifically, FIG. 9 illustrates a store commit path in the processor 16A (and to the L2 cache 18A, as applicable) for committing the store data. The store queue 44 is shown, coupled to receive a commit ready indication for a store, indicating that it can commit its data to memory. The store queue 44 is coupled to an L1 cache 50, which is coupled to a coherence trap detector 52 having a comparator 54 and the CT value register 40. The store queue 44 is also coupled to the L2 cache 18A, and more particularly to a tag memory 56. The tag memory 56 is coupled to a data memory 58 and a cache control unit 60. The cache control unit 60 is further coupled to the tag memory 58 and to supply a coherence trap indication to the trap logic in the processor 16A. It is noted that there may be one or more pipeline stages and buffers between the store queue 44 and the caches 50 and 18A, in various embodiments.

In response to the commit ready indication, the store queue 44 may read the store address and store data corresponding to the identified store to write the cache 50. The read need not occur immediately, and may be delayed for earlier stores or other reasons such as availability of a port on the cache 50. The store address and data are presented to the L1 cache 50. The L1 cache 50 may read the data that is being overwritten by the store, and may provide the data to the coherence trap detector 52. The coherence trap detector 52 may determine if the data is the CT value indicating a coherence trap, and may signal the trap, similar to the coherence trap detector 36 described above with regard to FIG. 8.

If the store cannot be completed in the L1 cache 50, the store may be presented to the L2 cache 18A. The L2 cache 18A may have a pipelined construction in which the tag memory 56 is accessed first, and the cache line that is hit (or a cache miss) may be determined. The tag memory 56 may store a plurality of cache tags that identify a plurality of cache lines stored in the cache data memory 58. The hit information may be used to access the correct portion of the cache data memory 58. If a miss is detected, the data memory 58 may not be accessed at all. Given this construction, it may be more complicated to detect the CT value in the cache data prior to committing the store. Accordingly, whether or not the cache line is storing the CT value may be tracked in the tag memory 56. The tag memory 56 may output a coherence trap value (CTV) set indication to the cache control unit 60 to indicate that the tag for the cache line indicates that a coherence trap is needed. The cache control unit 60 may signal the trap logic in the processor 16A in response, possibly qualifying the CTV set indication with other information (e.g. a mode bit indicating that the coherence trap is enabled, etc.).

While the L1 cache 50 is shown using a coherence trap detector 52 in this embodiment, other embodiments may track whether or not the cache data indicates a coherence trap in the L1 tag memory also, similar to the L2 cache 18A. In other embodiments, the L2 cache 18A may use a coherence trap detector similar to detector 52. Still further, in some embodiments, the L1 cache 50 may be write-through and may not allocate a cache line for a write miss. In such an embodiment, the data check for stores may only be performed on the L2 cache 18A.

If a store causes a coherence trap, the store may be retained in the store queue (or another storage location) to be reattempted after write permission has been established for the store. The coherence trap detector 52 is coupled to the store queue 44, the L1 cache 50, and the cache control unit 60 in the L2 cache 18A to facilitate such operation, in the illustrated embodiment. That is, the coherence trap detector 52 may signal the store queue 44, the L1 cache 50, and the cache control unit 60 of the trap for the store. The caches may prevent the cache line from being read while write permission is obtained, and the store queue 44 may retain the store.

Additionally, the coherence code executes with the store still stalled in the store queue 44. Accordingly, the store queue 44 may permit memory operations from the coherence code to bypass the stalled store. The processor 16A may support a mechanism for the coherence code to communicate that the store may be reattempted to the store queue 44 (e.g. a write to a processor-specific register), or the store queue 44 may continuously reattempt the store until the store succeeds. In one embodiment, the processor 16A may be multithreaded, including two or more hardware “strands” for concurrent execution of multiple threads. One strand may be dedicated to executing coherence code, and thus may avoid the store queue entry occupied by the stalled store that caused the coherence trap. In one particular embodiment, a dedicated entry or entries separate from the store queue 44 may be used by the coherence code (e.g. by writing processor-specific registers mapped to the entry). The dedicated entry(ies) may logically appear to be the head of the store queue 44, and may thus bypass the stalled store in the store queue 44.

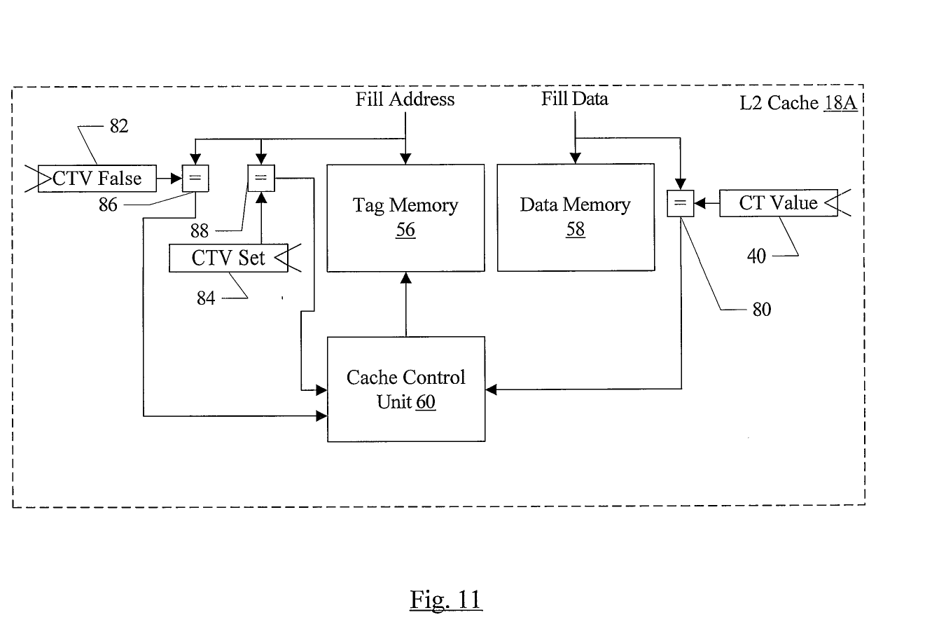

FIG. 10 is a block diagram illustrating one embodiment of a cache tag 70 from the tag memory 56 for one embodiment. The cache tag 70 includes an address tag field 72, a state field 74, and a CTV bit 76. The CTV bit 76 may logically be part of the state field 74, but is shown separately for illustrative purposes. The CTV bit 76 may track whether or not the cache line identified by the cache tag 70 in the data memory 58 is storing the CT value (or will be storing the CT value, if the CT value is in the process of being written to the cache line). For example, the bit may be set to indicate that the cache line is storing the designated value, and may be clear otherwise. Other embodiments may reverse the meaning of the set and clear states, or may use a multibit indication.

The state field 74 may store various other state (e.g. whether or not the cache line is valid and/or modified, replacement data state for evicting a cache line in the event of a cache miss, intranode coherence state as established by the intranode coherence scheme implemeted on the coherent interconnect 28, etc.). The address tag field 72 may store the tag portion of the address of the cache line (e.g. the address tag field may exclude cache line offset bits and bits used to index the cache to select the cache tag 70).

Turning now to FIG. 11, a block diagram of one embodiment of a portion of the L2 cache 18A is shown. Other L2 caches may be similar. The portion illustrated in FIG. 11 may be used when a missing cache line is loaded into the L2 cache 18A (referred to as a reload or a fill). Specifically, the portion shown in FIG. 11 may be used to establish the CTV bit in the tag for the cache line as the cache line is loaded into the cache.

As illustrated in FIG. 11, the tag memory 56 is coupled to receive the fill address and the data memory is coupled to receive the fill data. The fill address and data may be muxed into the input to the tag memory 56/data memory 58 with other address/data inputs. Additionally, the fill address and corresponding fill data may be provided at different times. A comparator 80 is also coupled to receive the fill data, or a portion thereof that is the size of the CT value. The comparator 80 also has another input coupled to the CT value register 40. If the data matches the CT value in the register 40, the comparator 80 signals the cache control unit 60. It is noted that the CT value register 40 shown in FIGS. 2, 3, and 5 may be logically the same register, but may physically be two or more copies of the register located near the circuitry that uses the register.

In addition to detecting the CT value in the fill data, certain additional checks may be implemented using the CTV false register 82 and the CTV set register 84, coupled to corresponding comparators 86 and 88 (each of which is coupled to receive the fill address). These checks may help to ensure that the CT value is correctly detected or not detected in the fill data. Both the CTV false register 82 and the CTV set register 84 may be accessible to software, similar to the CT value register 40.

The CTV false register 82 may be used by the software coherence routine to indicate when data actually has the CT value as the valid, accurate value for that memory location (and thus no coherence trap is needed). Software may write the address of the cache line with the CT value to the CTV false register 82. If the fill address matches the contents of the CTV false register 82, the cache control unit 60 may not set the CTV bit in the cache tag even though the comparator 80 asserts its output signal.

The CTV set register 84 may be used by the software coherence routine to indicate that a cache line that has not been fully set to the CT value is, in fact, invalid for coherence reasons. The CTV set register 84 may be used to cover the time when the cache line is being written, since the size of the largest store in the ISA is smaller than a cache line (e.g. 8 bytes vs. 64 bytes). Software may write the address of a cache line being written with the CT value to the CTV set register 84, and a match of the fill address to the contents of the CTV set register 84 may cause the cache control unit 60 to set the CTV bit, even if the CT value register 40 is not matched by the fill data.

It is noted that, in some embodiments, the amount of fill data (and/or data provided from a cache, e.g. the L1 cache 50 in FIG. 9) is larger than the CT value register. In one embodiment, the most significant data bytes from a cache line output from the cache, or within the fill data, may be compared to the CT value register to detect the CT value in the data. In another embodiment, the cache line data may be hashed in some fashion to compare the data. For example, if the CT value were 8 bytes, every 8th byte could by logically ANDed or ORed to produce an 8 byte value to compare to the CT value.

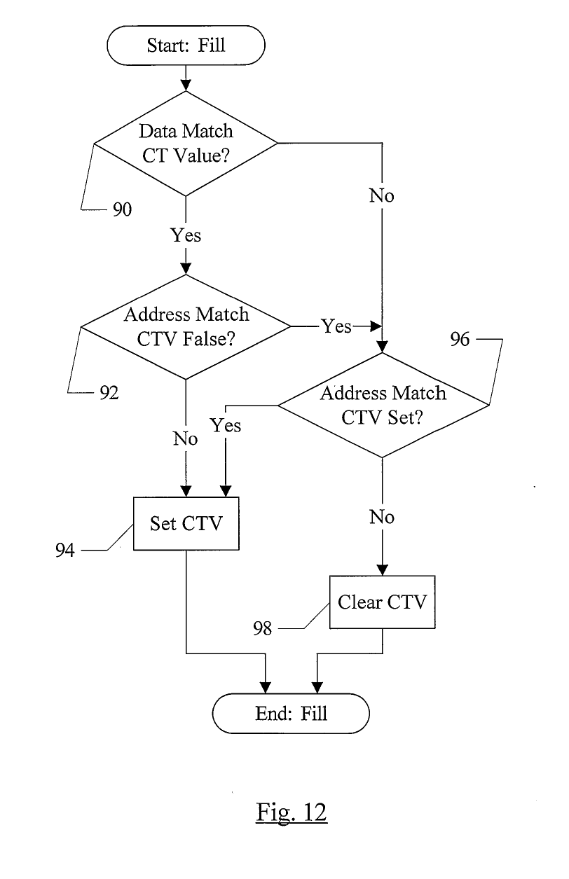

FIG. 12 is a flowchart illustrating operation of one embodiment of the cache control unit 60 during a fill operation to the L2 cache 18A. While the blocks are shown in a particular order for ease of understanding, any order may be used. Blocks may be performed in parallel in combinatorial logic in the cache control unit 60. Blocks, combinations of blocks, and/or the flowchart as a whole may be pipelined over multiple clock cycles. In each case of matching against a register value below, the match may be qualified with the contents of the register being valid.

If the fill data matches the CT value (decision block 90, “yes” leg) and the fill address does not match the CTV false address (decision block 92, “no” leg), the cache control unit 60 may set the CTV bit in the cache tag (block 94). The fill address may be considered to “not match” the CTV false address if the CTV false register is not valid or if the CTV false register is valid and the numerical values of the addresses do not match.

If the fill data does not match the CT value (decision block 90, “no” leg), but the fill address matches the CTV set address (decision block 96, “yes” leg), the cache control unit may also set the CTV bit in the cache tag (block 94). Otherwise, the cache control unit 60 may clear the CTV bit in the cache tag (block 98). Again, the fill address may be considered to “not match” the CTV set address if the CTV set register is not valid or if the CTV set register is valid and the numerical values of the addresses do not match. Similarly, the fill data may be considered to “not match” the CT value if the CT value register 40 is not valid or if the CT value register is valid and the numerical values of the data do not match.

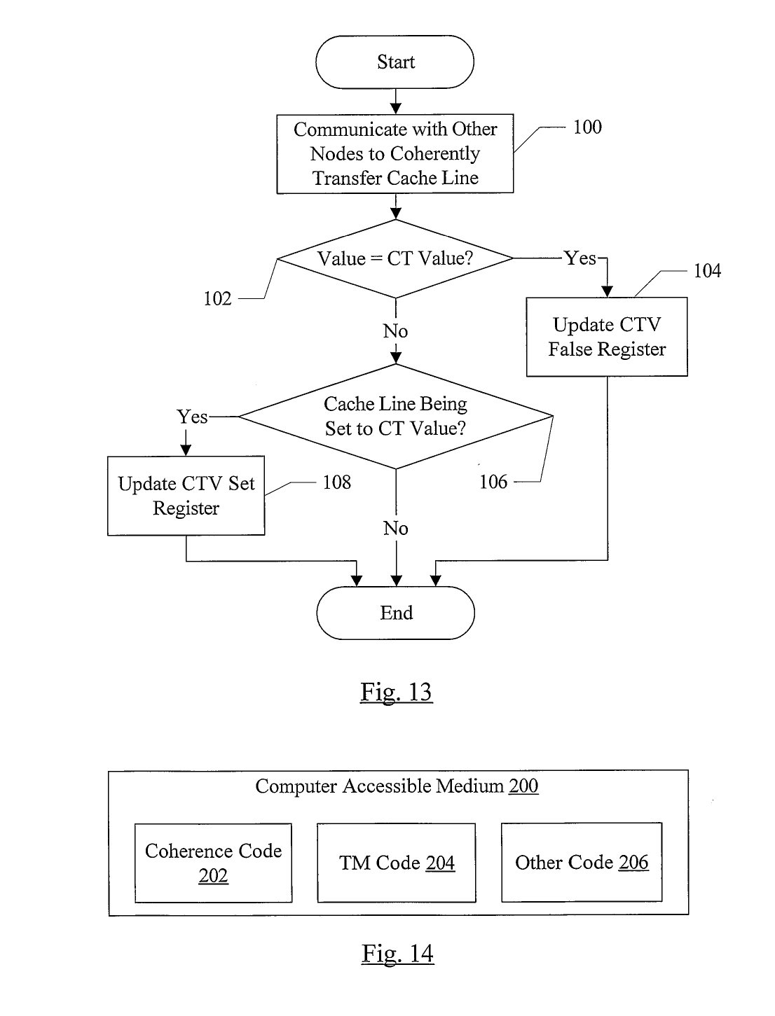

Turning now to FIG. 13, a flowchart is shown illustrating one embodiment of coherence code (software coherence routine(s)) that may be executed in response to a coherence trap to maintain coherence. While the blocks are shown in a particular order for ease of understanding, other orders may be used. The coherence code may comprise instructions which, when executed in the system 10, implement the operation shown in FIG. 13.

The coherence code may communicate with other nodes (e.g. the coherence code in other nodes) to coherently transfer the missing cache line to the node (block 100). Any software coherence protocol may be used. In one example, the coherence code in each node may maintain data structures in memory that identify which cache lines are shared with other nodes, as well as the nodes with which they are shared, which cache lines are modified in another node, etc. The coherence code may lock an entry in the data structure corresponding to the missing cache line, perform the transfer (obtaining the most recent copy) and unlock the entry. Other embodiments may use numerous other software mechanisms, including interrupting and non-interrupting mechanisms. It is noted that software may maintain coherence at a coarser or finer grain than a cache line, in other embodiments.

If the value in the cache line is the CT value, and should be the CT value (i.e. no coherence trap is being signalled (decision block 102, “yes” leg), the coherence code may update the CTV false register 82 with the address of the cache line so that no coherence trap will be signalled, at least while the data is in the L2 cache (block 104). On the other hand, if the coherence code is setting the cache line to the CT value (e.g. because the cache line ownership has been transferred to another node—decision block 106, “yes” leg), the coherence code may update the CTV set register with the address of the cache line (block 108).

Turning now to FIG. 14, a block diagram of a computer accessible medium 200 is shown. Generally speaking, a computer accessible medium may include any media accessible by a computer during use to provide instructions and/or data to the computer. For example, a computer accessible medium may include storage media. Storage media may include magnetic or optical media, e.g., disk (fixed or removable), tape, CD-ROM, or DVD-ROM, CD-R, CD-RW, DVD-R, DVD-RW. Storage media may also include volatile or non-volatile memory media such as RAM (e.g. synchronous dynamic RAM (SDRAM), Rambus DRAM (RDRAM), static RAM (SRAM), etc.), ROM, or Flash memory. Storage media may include non-volatile memory (e.g. Flash memory) accessible via a peripheral interface such as the Universal Serial Bus (USB) interface in a solid state disk form factor, etc. The computer accessible medium may include microelectromechanical systems (MEMS), as well as storage media accessible via transmission media or signals such as electrical, electromagnetic, or digital signals, conveyed via a communication medium such as a network and/or a wireless link. The computer accessible medium 200 in FIG. 14 may store the coherence code 202 mentioned above. The coherence code 202 may comprise instructions which, when executed, implement the operation described herein for the coherence code (e.g. as described above with regard to FIGS. 7 and/or 14. The computer accessible medium 200 may store transactional memory code (TM code) 204. The TM code 204 may comprise instructions which, when executed, implement the operation described herein for the TM code (e.g. as described above with regard to FIG. 6). The computer accessible medium 200 may also store other code 206, which may comprise instructions which, when executed, implement any operation describe herein as being implemented in software (e.g. debugging, simulation, etc.). Generally, the computer accessible medium 200 may store any set of instructions which, when executed, implement a portion or all of the flowcharts shown in one or more of FIGS. 6, 7, and 14.

Numerous variations and modifications will become apparent to those skilled in the art once the above disclosure is fully appreciated. It is intended that the following claims be interpreted to embrace all such variations and modifications.

What is claimed is:

1. A method comprising:
communicating with one or more other nodes in a system from a first node in the system in response to a trap experienced by a processor in the first node during a memory operation, wherein the trap is signalled in the processor in response to one or more permission bits stored with a cache line in a cache accessible during performance of the memory operation;
determining that the cache line is part of a memory transaction in a second node that is one of the other nodes, wherein a memory transaction comprises two or more memory operations that appear to execute atomically in isolation; and
resolving a conflict between the memory operation and the memory transaction.

2. The method as recited in claim 1 wherein resolving the conflict comprises delaying the memory operation until the memory transaction in the second node completes.

3. The method as recited in claim 1 wherein the memory operation is part of a local memory transaction in the first node, and wherein the conflict is between the local memory transaction and the memory transaction in the second node.

4. The method as recited in claim 3 wherein resolving the conflict comprises aborting the local memory transaction.

5. The method as recited in claim 3 wherein resolving the conflict comprises aborting the memory transaction in the second node.

6. The method as recited in claim 1 wherein the one or more permission bits comprise a read permission bit indicating whether or not the first node has read permission to the respective cache line and a write permission bit indicating whether or not the first node has write permission to the respective cache line.

7. The method as recited in claim 1 further comprising updating the permission bits for the respective cache line responsive to the resolving.

8. The method as recited in claim 1 further comprising using the permission bits to ensure coherence of the respective cache line.

9. The method as recited in claim 8 further comprising:
trapping a load memory operation responsive to the permission bits indicating that the first node does not have read permission to the respective cache line;
coherently transferring the respective cache line to the first node; and
updating the permission bits to indicate read permission.

10. The method as recited in claim 8 further comprising:
trapping a store memory operation responsive to the permission bits indicating that the first node does not have write permission to the respective cache line;
coherently transferring the respective cache line to the first node; and
updating the permission bits to indicate write permission.

11. The method as recited in claim 1 further comprising using the permission bits to trap memory accesses during debugging.

12. The method as recited in claim 1 further comprising using the permission bits to trap memory accesses during simulation.

13. The method as recited in claim 1 further comprising using the permission bits to set watch points at a cache line granularity.

14. A computer accessible storage medium store a plurality of instructions that are executable to perform a method comprising:
communicating with one or more other nodes in a system from a first node in the system in response to a trap experienced by a processor in the first node during a memory operation, wherein the trap is signalled in the processor in response to one or more permission bits stored with a cache line in a cache accessible during performance of the memory operation;
determining that the cache line is part of a memory transaction in a second node that is one of the other nodes, wherein a memory transaction comprises two or more memory operations that appear to execute atomically in isolation; and
resolving a conflict between the memory operation and the memory transaction.

15. The computer accessible storage medium as recited in claim 14 wherein the method further comprises updating the permission bits for the respective cache line responsive to the resolving.

16. The computer accessible storage medium as recited in claim 14 wherein the method further comprises using the permission bits to ensure coherence of the respective cache line.

17. A cache comprising:
a tag memory configured to store a plurality of cache tags, wherein each cache tag corresponds to a respective cache line of data stored in the cache, and wherein each cache tag comprises one or more bits that indicate whether or not a memory operation to the respective cache line is to be trapped in a processor that performs the memory operation; and
a cache control unit coupled to the tag memory and configured to signal a trap for a memory operation responsive to the bits from the cache tag.

18. The cache as recited in claim 17 wherein the one or more bits comprise a read permission bit indicating whether or not a node that includes the cache has read permission to the respective cache line and a write permission bit indicating whether or not the node has write permission to the respective cache line.

19. The cache as recited in claim 18 wherein the cache control unit is configured to signal the trap for a load memory operation responsive to the read permission bit indicating no read permission.

20. The cache as recited in claim 18 wherein the cache control unit is configured to signal the trap for a store memory operation responsive to the write permission bit indicating no write permission.

21. The cache as recited in claim 17 wherein the one or more bits are also stored with the respective cache line in a main memory system, and wherein the one or more bits are loaded into the cache with the respective cache line.
